(19) United States
(12) Patent Application Publication
(10) Pub. No.: US 2025/0059421 A1
(43) Pub. Date: Feb. 20, 2025

(54) MIXED REFRIGERANT COMPOSITION AND HEAT PUMP INCLUDING THE SAME

(71) Applicants: SK INNOVATION CO., LTD., Seoul (KR); SK Enmove Co., Ltd., Seoul (KR)

(72) Inventors: Bong Ho KANG, Daejeon (KR); Hye Ri KIM, Daejeon (KR); Ji Seong NOH, Daejeon (KR); Sang Gu WOO, Daejeon (KR); Jae Min LEE, Daejeon (KR)

(21) Appl. No.: 18/806,643

(22) Filed: Aug. 15, 2024

(30) Foreign Application Priority Data
Aug. 16, 2023 (KR) 10-2023-0106988
Jul. 17, 2024 (KR) 10-2024-0094667

(51) Int. Cl. C09K 5/04

(52) U.S. Cl. CPC C09K 5/045; C09K 2205/126

(57) ABSTRACT

A mixed refrigerant composition includes carbon dioxide (R-744), 2,3,3,3-tetrafluoropropene (R-1234yf) and 1,1-difluoroethane (R-152a). A content of the carbon dioxide (R-744) ranges from 1 to 10 wt. % based on a total weight of the mixed refrigerant composition, and a content of the 2,3,3,3-tetrafluoropropene (R-1234yf) ranges from 65 to 95 wt. % based on the total weight of the mixed refrigerant composition, and a content of the 1,1-difluoroethane (R-152a) ranges from 1 to 30 wt. % based on the total weight of the mixed refrigerant composition. A boiling point at 1 atm of the mixed refrigerant composition ranges from −65 to −30° C.

### CROSS REFERENCE TO RELATED APPLICATION

This application claims priority under 35 U.S.C. § 119 to Korean Patent Application Nos. 10-2023-0106988 filed on Aug. 16, 2023, and 10-2024-0094667 filed on Jul. 17, 2024 in the Korean Intellectual Property Office. The entire disclosure of each of the foregoing applications is incorporated herein by reference in its entirety.

### BACKGROUND OF THE INVENTION

### 1. Field of the Invention

The present invention relates to a composition operable as a refrigerant, and a heat pump including the same.

### 2. Description of the Related Art

Refrigerants are substances used to remove heat from heat pumps utilized in air conditioners, refrigerators, cooling towers and the like. The refrigerants may include, for example, natural refrigerants, chlorofluorocarbon (CFC)-based refrigerants, hydrochlorofluorocarbon (HCFC)-based refrigerants, hydrofluorocarbon (HFC)-based refrigerants, and hydrofluoroolefin (HFO)-based refrigerants.

Recently, types of heat pumps used indoors and outdoors have become more diverse, and due to the development of electric vehicles, etc., the miniaturized heat pumps are required. Further, in the case of refrigerants containing chlorine (Cl), these refrigerants may cause ozone layer destruction, etc., such that the development of refrigerants which do not contain chlorine atoms is underway.

For example, 2,3,3,3-tetrafluoropropane (R-1234yf) which is a type of hydrofluoroolefin-based refrigerant does not contain chlorine atoms. Therefore, this substance is actively used as a refrigerant in air conditioners for a vehicles due to a low global warming potential (GWP).

However, when 2,3,3,3-tetrafluoropropene is used as a refrigerant in the air conditioners for vehicles due to its low coefficient of performance (COP), there is a problem that the performance of the air conditioners is decreased since an additional heat pump is required.

Therefore, there is a need to develop a refrigerant or combination of refrigerants which have a high coefficient of performance while capable of suppressing environmental pollution.

### SUMMARY OF THE INVENTION

One of the various embodiments of the present disclosure provides a mixed refrigerant composition with improved environmental friendliness.

Other of the various embodiments of the present disclosure provides a heat pump which includes the mixed refrigerant composition, and has improved cooling performance.

According to one aspect of the present disclosure, there is provided a mixed refrigerant composition including carbon dioxide (R-744), 2,3,3,3-tetrafluoropropene (R-1234yf) and 1,1-difluoroethane (R-152a), wherein a content of the carbon dioxide (R-744) ranges from 1 to 10% by weight based on a total weight of the mixed refrigerant composition, a content of the 2,3,3,3-tetrafluoropropene (R-1234yf) ranges from 65 to 95% by weight based on the total weight of the mixed refrigerant composition, a content of the 1,1-difluoroethane (R-152a) ranges from 1 to 30% by weight based on the total weight of the mixed refrigerant composition, and a boiling point of the mixed refrigerant composition at 1 atm ranges from −65 to −30° C.

The mixed refrigerant composition according to various embodiments of the present disclosure may consist of the carbon dioxide (R-744), the 2,3,3,3-tetrafluoropropene (R-1234yf), and the 1,1-difluoroethane (R-152a).

In various embodiments, the content of the 1,1-difluoroethane (R-152a) may range from 13 to 25% by weight based on the total weight of the mixed refrigerant composition.

In various embodiments, the content of the 1,1-difluoroethane (R-152a) may range from 18 to 23% by weight based on the total weight of the mixed refrigerant composition.

In various embodiments, a ratio of the content of the 2,3,3,3-tetrafluoropropene (R-1234yf) to the content of the carbon dioxide (R-744) based on the total weight of the mixed refrigerant composition may range from 6 to 95.

In various embodiments, a ratio of the content of the 1,1-difluoroethane (R-152a) to the content of the carbon dioxide (R-744) based on the total weight of the mixed refrigerant composition may range from 0.5 to 30.

In various embodiments, a ratio of the content of the 2,3,3,3-tetrafluoropropene (R-1234yf) to the content of the 1,1-difluoroethane (R-152a) based on the total weight of the mixed refrigerant composition may range from 2 to 19.

In various embodiments, a critical temperature of the mixed refrigerant composition may range from 90 to 100° C.

In various embodiments, a critical pressure of the mixed refrigerant composition may range from 30 to 51 bar.

In various embodiments, a temperature glide at a pressure of 1.5 bar of the mixed refrigerant composition may range from 3 to 29° C.

In various embodiments, a temperature glide at a pressure of 15 bar of the mixed refrigerant composition may range from 2 to 23° C.

In various embodiments, a latent heat at −25° C. of the mixed refrigerant composition may range from 150 to 250 kJ/kg.

In various embodiments, a global warming potential (GWP) of the mixed refrigerant composition may range from 1 to 40.

According to another aspect of the present disclosure, there is provided a heat pump operable with the mixed refrigerant composition according to the embodiments of the present disclosure.

According to another aspect of the present disclosure, there is provided a mixed refrigerant composition comprising: a natural refrigerant and a mixture of two or more artificial refrigerants, the artificial refrigerants having a zero ozone depleting potential. The mixed refrigerant composition includes no chlorine. A content of the natural refrigerant ranges from 1 to 10% by weight based on a total weight of the mixed refrigerant composition. A content of a first artificialrefrigerant of the two artificial refrigerants ranges from 65 to 90% by weight based on the total weight of the mixed refrigerant composition, and the first artificial refrigerant has a global warming potential of less than 4. A content of a second artificial refrigerant of the two artificial refrigerant ranges from 1 to 30% by weight based on the total weight of the mixed refrigerant composition, and the second artificial refrigerant has a global warming potential of less than 150. A boiling point for the mixed refrigerant composition at 1 atm ranges from −65 to −35° C.

In some embodiments, the natural refrigerant comprises at least one or more of ammonia, carbon dioxide, propane, propylene, and butane.

In some embodiments, the artificial refrigerants comprise hydrofluorocarbon (HFC)-based refrigerants and hydrofluoroolefm (HFO)-based refrigerants.

In the mixed refrigerant composition according to various embodiments of the present disclosure, the refrigerant included in the mixed refrigerant composition may not contain chlorine atoms (Cl), thus environmental pollution such as ozone layer destruction can be suppressed.

The mixed refrigerant composition according to various embodiments of the present disclosure may effectively decrease the ambient temperature during vaporization from liquid to gas even at a low temperature.

In addition, the mixed refrigerant composition may not be phase converted to a supercritical state while a cooler such as an air conditioner is operated. Accordingly, the condensation pressure of the compressor may not be reduced, and the coefficient of performance of a heat pump including the mixed refrigerant composition may be improved, resulting in lower power consumption.

### BRIEF DESCRIPTION OF THE DRAWINGS

The above and other features and other advantages of the present disclosure will be more clearly understood from the following detailed description taken in conjunction with the accompanying drawings, in which:

FIGS. 1 and 2 are schematic views illustrating the flow of a mixed refrigerant for heat exchange in a cooling mode or a heating mode of a heat exchanger according to various embodiments of the present disclosure, respectively.

### DETAILED DESCRIPTION OF THE INVENTION

According to various embodiments of the present disclosure, a mixed refrigerant composition including carbon dioxide (R-744), 2,3,3,3-tetrafluoropropene (R-1234yf) and 1,1-difluoroethane (R-152a), and a heat pump operable with the mixed refrigerant composition are provided.

Hereinafter, the present disclosure will be described in detail. However, the embodiments are merely illustrative and the present disclosure is not limited to the specific embodiments described by way of the examples given below.

According to various embodiments of the present disclosure, refrigerants included in the mixed refrigerant composition may be refrigerants which do not contain chlorine atoms (Cl). Examples of the refrigerants which do not contain chlorine atoms (Cl) may include natural refrigerants, hydrofluorocarbon (HFC)-based refrigerants, and hydrofluoroolefin (HFO)-based refrigerants.

The natural refrigerant is a substance that exists naturally on earth rather than as an artificial compound. For example, the natural refrigerant may include at least one of ammonia (R-717), carbon dioxide (R-744), propane (R-290), propylene (R-1270) and butane (R-600a).

The hydrofluorocarbon (HFC)-based refrigerant is a refrigerant composed of hydrogen atoms (H), fluorine atoms (F) and carbon atoms (C). The hydrofluorocarbon (HFC)-based refrigerant may include, for example, at least one or more of difluoromethane (R-32), trifluoroiodomethane (R-13I1), 1,1-difluoroethane (R-152a), pentafluoroethane (R-125), 1,1,1-trifluoroethane (R-143a), trifluoromethane (R-23), fluoroethane (R-161), 1,1,1,2,3,3,3-heptafluoropropane (R-227ea), 1,1,1,2,3,3-hexafluoropropane (R-236ea), 1,1,1,3,3,3-hexafluoropropane (R-236fa), 1,1,1,3,3-pentafluoropropane (R-245fa) and 1,1,1,3,3-pentafluorobutane (R-365mfc).

The hydrofluoroolefin (HFO)-based refrigerant is a refrigerant composed of hydrogen atoms (H), fluorine atoms (F) and carbon atoms (C), and has at least one double bond between the carbon atoms. The hydrofluoroolefin (HFO)-based refrigerant may include, for example, at least one or more of 1,1,2-trifluoroethylene (R-1123), 2,3,3,3-tetrafluoropropene (R-1234yf), 1,3,3,3-tetrafluoropropene (R-1234ze), 1,2,3,3-tetrafluoropropene (R-1234ye), 3,3,3-trifluoropropene (R-1243zf), 1,1-difluoroethylene (R-1132a) and 1,2,3,3,3-pentafluoropropene (R-1225ye).

The mixed refrigerant composition according to various embodiments of the present disclosure includes carbon dioxide (R-744), 2,3,3,3-tetrafluoropropene (R-1234yf) and 1,1-difluoroethane (R-152a). The carbon dioxide (R-744), the 2,3,3,3-tetrafluoropropene (R-1234yf) and the 1,1-difluoroethane (R-152a) included in the mixed refrigerant composition do not contain chlorine atoms (Cl).

The carbon dioxide (R-744) is a type of the natural refrigerant, and has an ozone depleting potential (ODP) of 0 and a global warming potential (GWP) of 1. In addition, the carbon dioxide (R-744) is not corrosive, toxic, or explosive. Due to the carbon dioxide (R-744) included in the mixed refrigerant composition, the environmental friendliness and stability of the mixed refrigerant composition is improved.

The 2,3,3,3-tetrafluoropropene (R-1234yf) is a type of hydrofluoroolefin (HFO)-based refrigerant, and has an ozone depleting potential (ODP) of 0 and a global warming potential (GWP) of 4 or less. In addition, R-1234yf has a high thermal stability and a high evaporative latent heat. As the 2,3,3,3-tetrafluoropropene (R-1234yf) is included in the mixed refrigerant composition, the environmental friendliness, thermal stability and refrigeration capacity of the mixed refrigerant composition is improved.

The 1,1-difluoroethane (R-152a) is a type of the hydrofluorocarbon (HFC)-based refrigerant, and has an ozone depleting potential (ODP) of 0 and a global warming potential (GWP) of 150 or less. The 1,1-difluoroethane (R-152a) may have a low molecular mass and a low saturation density. Due to the 1,1-difluoroethane (R-152a) included in the mixed refrigerant composition, the environmental friendliness of the mixed refrigerant composition may be improved. In addition, a discharge pressure from a compressor may be low due to the low saturation density. Therefore, a change in the enthalpy at the same pressure may be increased. Accordingly, refrigeration capacity of the mixed refrigerant composition may be improved.

In some embodiments of the present disclosure, the mixed refrigerant composition may not be mixed with any refrigerant other than the carbon dioxide (R-744), 2,3,3,3-tetrafluoropropene (R-1234yf) and 1,1-difluoroethane (R-152a). For example, the mixed refrigerant composition may not include an additional hydrofluorocarbon (HFC)-based refrigerant such as difluoromethane (R-32) having a high global warming potential.

Accordingly, the environmental friendliness of the mixed refrigerant composition may be improved. For example, the mixed refrigerant composition may not include an additional hydrofluoroolefm (HFO)-based refrigerant such as 1,1-difluoroethylene (R-1132a) having toxicity to humans. Thereby, even if some of the mixed refrigerant composition flows out from the heat pump, the impact to the environment is minimal.

In one embodiment, the mixed refrigerant composition consists only of carbon dioxide (R-744), 2,3,3,3-tetrafluoropropene (R-1234yf) and 1,1-difluoroethane (R-152a). Accordingly, it is possible to prevent the thermal and chemical stabilities of the mixed refrigerant composition from being reduced due to the refrigerant having a low thermal or chemical stability mixed therewith. In addition, it is possible to prevent the condensation temperature from being increased due to the refrigerant having a low vapor pressure mixed therewith, or the refrigeration capacity from being reduced due to the refrigerant having a low evaporative latent heat mixed therewith.

According to various embodiments of the present disclosure, a content of the carbon dioxide (R-744) may range from 1 to 10% by weight (“wt. %”), 1 to 8 wt. %, 1 to 6 wt. %, or 1 to 5 wt. % based on a total weight of the mixed refrigerant composition. If the content of the carbon dioxide (R-744) is less than 1 wt. % based on the total weight of the mixed refrigerant composition, the global warming potential (GWP) of the mixed refrigerant composition may be increased. Accordingly, environmental friendliness may be reduced. If the content of the carbon dioxide (R-744) exceeds 10 wt. % based on the total weight of the mixed refrigerant composition, the refrigeration capacity of the mixed refrigerant composition may be reduced. Thereby, the cooling characteristics of the mixed refrigerant composition may be decreased. Within the above content range, refrigeration performance may not be reduced while decreasing the global warming potential (GWP) of the mixed refrigerant composition. Accordingly, the environmental friendliness and cooling characteristics of the mixed refrigerant composition may be improved.

In some embodiments of the present disclosure, the content of the carbon dioxide (R-744) may range from 1.5 to 5 wt. %, 2 to 5 wt. %, 3 to 5 wt. %, 4 to 5 wt. %, or 4.5 to 5 wt. % based on the total weight of the mixed refrigerant composition. Within the above content range, the environmental friendliness and cooling characteristics of the mixed refrigerant composition may be further improved.

According to various embodiments of the present disclosure, a content of the 2,3,3,3-tetrafluoropropene (R-1234yf) may range from 65 to 95 wt. %, and 70 to 95 wt. %, 70 to 90 wt. %, or 75 to 90 wt. % based on the total weight of the mixed refrigerant composition. If the content of the 2,3,3,3-tetrafluoropropene (R-1234yf) is less than 65 wt. % based on the total weight of the mixed refrigerant composition, the content of the 1,1-difluoroethane (R-152a) may be increased, such that thermal stability may be decreased. In addition, the content of the carbon dioxide (R-744) may be increased, such that cooling capacity may be decreased. If the content of the 2,3,3,3-tetrafluoropropene (R-1234yf) exceeds 95 wt. % based on the total weight of the mixed refrigerant composition, the content of the 1,1-difluoroethane (R-152a) may be decreased, such that the cooling capacity may be reduced. Within the above content range, the thermal stability, cooling capacity, and environmental friendliness of the mixed refrigerant composition may be improved.

In some embodiments, the content of the 2,3,3,3-tetrafluoropropene (R-1234yf) may range 75 to 90 wt. %, 75 to 89 wt. %, 75 to 88 wt. %, 75 to 87 wt. %, or 75 to 85 wt. % based on the total weight of the mixed refrigerant composition. Within the above content range, the thermal stability and refrigeration capacity of the mixed refrigerant composition may be further improved.

According to various embodiments of the present disclosure, a content of 1,1-difluoroethane (R-152a) may range from 1 to 30 wt. %, 3 to 30 wt. %, or 5 to 30 wt. % based on the total weight of the mixed refrigerant composition. If the content of the 1,1-difluoroethane (R-152a) is less than 1 wt. % based on the total weight of the mixed refrigerant composition, refrigeration capacity may be reduced. If the content of the 1,1-difluoroethane (R-152a) exceeds 30 wt. % based on the total weight of the mixed refrigerant composition, the global warming potential (GWP) value may be increased. Accordingly, the environmental friendliness of the mixed refrigerant composition may be reduced. Within the above range, cooling capacity may be improved while the environmental friendliness of the mixed refrigerant composition is increased.

In some embodiments of the present disclosure, the content of the 1,1-difluoroethane (R-152a) may range from 10 to 30 wt. %, 10 to 25 wt. %, 13 to 25 wt. %, 15 to 25 wt. %, 15 to 23 wt. %, or 18 to 23 wt. % based on the total weight of the mixed refrigerant composition. Within the above content range, the environmental friendliness of the mixed refrigerant composition is increased, as well as the cooling capacity may be further improved, and the evaporative latent heat of the mixed refrigerant composition may be further increased. Accordingly, the refrigeration capacity may be further increased.

In some embodiments of the present disclosure, a ratio of the content of the 2,3,3,3-tetrafluoropropene (R-1234yf) to the content of the carbon dioxide (R-744) based on the total weight of the mixed refrigerant composition may range from 6 to 95, 6 to 90, 10 to 85, 10 to 80, or 13 to 80. Within the above range, the thermal stability, environmental friendliness, and refrigeration capacity of the mixed refrigerant composition may be improved.

In one embodiment of the present disclosure, the ratio of the content of the 2,3,3,3-tetrafluoropropene (R-1234yf) to the content of the carbon dioxide (R-744) based on the total weight of the mixed refrigerant composition may range from 13 to 60, 13 to 45, 13 to 40, 13 to 35, 13 to 30, 13 to 25, 13 to 20, or 13 to 18. Within the above range, the thermal stability, environmental friendliness, and refrigeration capacity of the mixed refrigerant composition may be further improved.

In some embodiments of the present disclosure, a ratio of the content of the 1,1-difluoroethane (R-152a) to the content of the carbon dioxide (R-744) based on the total weight of the mixed refrigerant composition may range from 0.5 to 30, 25 to 25, 1 to 20, or 1 to 15.

Within the above range, the cooling capacity of the mixed refrigerant composition may be improved.

In one embodiment of the present disclosure, the ratio of the content of the 1,1-difluoroethane (R-152a) to the content of the carbon dioxide (R-744) based on the total weight of the mixed refrigerant composition may range from 1 to 15, 1 to 10, 1 to 7, or 1 to 6. Within the above range, the cooling capacity of the mixed refrigerant composition may be further improved.

In some embodiments of the present disclosure, the ratio of the content of the 2,3,3,3-tetrafluoropropene (R-1234yf) to the content of the 1,1-difluoroethane (R-152a) based on the total weight of the mixed refrigerant composition may range from 2 to 19, 2 to 18, 2 to 15, 2 to 10, 3 to 10, 3 to 9, or 3 to 6. Within the above range, the thermal stability and refrigeration capacity may be improved.

In one embodiment of the present disclosure, the ratio of the content of the 2,3,3,3-tetrafluoropropene (R-1234yf) to the content of the 1,1-difluoroethane (R-152a) based on the total weight of the mixed refrigerant composition may range from 3.5 to 6, 3.5 to 5.5, 3.5 to 5.4, 3.5 to 5, or 3.5 to 4. Within the above range, the thermal stability and refrigeration capacity of the mixed refrigerant composition may be further improved.

According to various embodiments of the present disclosure, a boiling point at 1 atm of the mixed refrigerant composition may range from −65 to −30° C., −60 to −30° C., −55 to −34° C., or −55° C. to −40° C.

If the boiling point of the mixed refrigerant composition is less than −65° C., a condensation pressure at the condensation temperature of the mixed refrigerant composition may be increased. Therefore, energy consumed in the refrigeration cycle may be increased, and an efficiency of the refrigerant may be decreased.

If the boiling point of the mixed refrigerant composition exceeds −30° C., a specific volume at the condensation temperature of the mixed refrigerant composition may be increased. Accordingly, an amount of the mixed refrigerant composition required to improve refrigeration capacity is increased, such that a volume of an air conditioner may be increased.

In some embodiments of the present disclosure, a boiling point at 1 atm of the mixed refrigerant composition may range from −55 to −45° C., −53 to −45° C., or −53 to −48° C. Within the above boiling point range of the mixed refrigerant composition, the specific volume may be decreased without increasing the condensation pressure. Therefore, the refrigeration capacity of the refrigerant may be improved while reducing the amount of mixed refrigerant composition.

In some embodiments of the present disclosure, a critical temperature of the mixed refrigerant composition may range from 90 to 100° C., 95 to 100° C., 97 to 100° C., or 97 to 99° C. The critical temperature refers to a maximum temperature at which a specific substance may exist in a liquid state. If the critical temperature of the refrigerant is low, it may be difficult to liquefy the refrigerant in the refrigeration cycle.

Within the above critical temperature range, the mixed refrigerant composition may not become a supercritical fluid state in the refrigeration cycle. Therefore, it is possible to prevent a portion of the mixed refrigerant composition from reaching the supercritical fluid state to be not liquefied, and thus the refrigeration capacity may be improved.

In some embodiments of the present disclosure, a critical pressure of the mixed refrigerant composition may range from 30 to 51 bar, 30 to 50 bar, 35 to 50 bar, 35 to 45 bar, 39 to 45 bar, or 40 to 45 bar. The critical pressure refers to a maximum pressure at which a specific substance may exist in a liquid state. If the critical pressure of the refrigerant is high, it may be difficult to liquefy the refrigerant in the refrigeration cycle.

Within the above critical pressure range, the mixed refrigerant composition may not become the supercritical fluid state in the refrigeration cycle. Therefore, it is possible to prevent a portion of the mixed refrigerant composition from not being liquefied, and thus the refrigeration capacity may be improved.

In some embodiments of the present disclosure, a temperature glide at a pressure of 1.5 bar of the mixed refrigerant composition may range from 3 to 29° C., 3 to 28° C., 8 to 27° C., 10 to 26° C., 11 to 26° C., 11 to 25° C., 11 to 20° C., or 15 to 20° C. Temperature glide refers to the difference between the saturated vapor temperature and saturated liquid temperature of a refrigerant at a constant pressure. Within the above temperature glide range, composition separation may not occur even if the mixed refrigerant leaks out. Accordingly, the use capacity of the mixed refrigerant composition may be improved even if a heat pump of the same volume is used.

In some embodiments of the present disclosure, the temperature glide at a pressure of 15 bar of the mixed refrigerant composition may range from 2 to 23° C., 2 to 13° C., 4 to 13° C., 4.5 to 13° C., 5 to 13° C., 6.5 to 13° C., 9 to 13° C., or 11 to 13° C. Within the above temperature glide range, composition separation may not occur even if the mixed refrigerant composition is used in a heat pump. Accordingly, the heat transfer efficiency of the refrigerant may be improved.

In some embodiments of the present disclosure, a latent heat at −25° C. of the mixed refrigerant composition may range from 150 to 250 kJ/kg, 180 to 250 kJ/kg, 180 to 230 kJ/kg, 180 to 220 kJ/kg, 190 to 220 kJ/kg, 195 to 220 kJ/kg, 200 to 215 kJ/kg, or 205 to 215 kJ/kg.

Within the above latent heat range, the heat released or absorbed during the phase change of the mixed refrigerant composition may be sufficient. Accordingly, the thermal efficiency of the mixed refrigerant composition may be improved.

In some embodiments of the present disclosure, the global warming potential (GWP) of the mixed refrigerant composition may range from 1 to 40, 1 to 30, 5 to 30, 10 to 30, 10 to 28, 15 to 28, or 19 to 28.

The global warming potential (GWP) is a value obtained by calculating a degree of effect on global warming using carbon dioxide (CO₂) as a reference material over a certain period of time (for example, 100 years), when 1 kg of any chemical substance is released into the Earth's troposphere.

Within the above global warming potential range, the cooling capacity may be improved while suppressing environmental pollution caused by use and treatment of the mixed refrigerant composition.

In some embodiments of the present disclosure, the ozone depleting potential (ODP) of the mixed refrigerant composition may be 0.

The ozone depleting potential (ODP) is a value obtained by calculating a degree of effect on ozone layer destruction by any chemical substance, when assuming that the effect of trichlorofluoromethane (CFC-11) on the ozone layer destruction is 1.

As the ozone depleting potential (ODP) is 0, environmental pollution caused by use and treatment of the mixed refrigerant composition may be suppressed.

In some embodiments of the present disclosure, the mixed refrigerant composition may be non-flammable. For example, the mixed refrigerant composition may have a flammability of Class A2L in the refrigerant safety group classification of the American Society of Heating, Refrigerating and Air-Conditioning Engineers (ASHRAE). Accordingly, stability during operation and leakage of the heat pump may be improved.

According to various embodiments of the present disclosure, the heat pump includes the mixed refrigerant composition(s) described above. Accordingly, the refrigeration performance of the heat pump may be enhanced, while improving the environmental friendliness and stability.

The heat pump may include a compressor, a condenser, an expansion valve and an evaporator. In the compressor, the above-described mixed refrigerant composition(s) may be compressed to a high temperature and high pressure state, and in the expansion valve, the above-described mixed refrigerant composition may be expanded to a low temperature and low pressure state.

For example, the above-described mixed refrigerant composition(s) may emit or absorb heat while circulating through the compressor, the condenser, the expansion valve, and the evaporator inside the heat pump. The mixed refrigerant composition may be maintained in a gaseous state at high temperature and high pressure in the compressor. The mixed refrigerant composition(s) may be liquefied into a liquid state by releasing the heat in the condenser. The mixed refrigerant composition may be maintained in a low-temperature and low-pressure liquid state, or a mixture state of liquid and gas in the expansion valve. The mixed refrigerant composition(s) may absorb the heat to be vaporized into a gaseous state in the evaporator.

In some embodiments of the present disclosure, the heat pump may contain oil. For example, the oil may include paraffin, naphthene, aromatic hydrocarbon, polyester (POE), polyol ester, mineral oil, alkylbenzene (AB), and polyalkylene glycol (PAG), polyvinyl ether (PVE) and the like. Accordingly, friction and wear of the heat pump may be prevented.

In some embodiments, a coefficient of performance (COP) of the heat pump may be 1 to 10. The coefficient of performance (COP) refers to a ratio of an amount of heat effectively gained to an amount of work input when operating the heat pump.

A highly efficient heat pump having the coefficient of performance in the above range may be provided using the above-described refrigerant.

Hereinafter, experimental examples including specific examples and comparative examples are provided to facilitate understanding of the present disclosure. However, the following examples are only given for illustrating the present disclosure, and those skilled in the art will understand that various alterations and modifications are possible within the scope of the present disclosure.

### Examples and Comparative Examples

### (1) Mixed Refrigerant Composition

Mixed refrigerant compositions having the components and contents (wt. %) shown in Table 1 below were prepared.

The boiling point, critical temperature, critical pressure, temperature glide at 1.5 bar and 15 bar, and latent heat at −25° C. of each of the prepared mixed refrigerant compositions were measured. The measured boiling points, critical temperatures, critical pressure, temperature glides at 1.5 bar and 15 bar, and latent heats at −25° C. of the mixed refrigerant compositions are shown in Table 1.

The boiling point, critical temperature, critical pressure, temperature glide, and latent heat of the mixed refrigerant composition were measured using REFPROP (Version 10, NIST).

TABLE 1

| | Content of each | | | | | | | | |
|---|---|---|---|---|---|---|---|---|---|
| | component of mixed | | | | | | | | |
| | refrigerant composition | | | Boiling | Critical | Critical | Temperature glide | | Latent heat |
| | (wt. %) | | | point | temperature | pressure | at 1.5 bar | at 15 bar | at −25° C. |
| Item | R-744 | R-1234yf | R-152a | (° C.) | (° C.) | (bar) | (° C.) | (° C.) | (kJ/kg) |
| Example 1 | 1 | 94 | 5 | −35.587 | 96.069 | 36.306 | 4.873 | 2.418 | 186.00 |
| Example 2 | 1 | 89 | 10 | −35.338 | 96.603 | 36.873 | 4.666 | 2.359 | 192.95 |
| Example 3 | 1 | 84 | 15 | −35.082 | 97.199 | 37.431 | 4.502 | 2.304 | 199.97 |
| Example 4 | 1 | 79 | 20 | −34.819 | 97.861 | 37.986 | 4.385 | 2.262 | 207.10 |
| Example 5 | 2 | 93 | 5 | −40.701 | 96.569 | 37.976 | 9.264 | 4.909 | 187.30 |
| Example 6 | 2 | 88 | 10 | −40.266 | 97.017 | 38.478 | 8.899 | 4.780 | 194.25 |
| Example 7 | 2 | 83 | 15 | −39.851 | 97.528 | 38.971 | 8.601 | 4.668 | 201.31 |
| Example 8 | 2 | 78 | 20 | −39.454 | 98.128 | 38.476 | 8.373 | 4.575 | 208.45 |
| Example 9 | 3 | 92 | 5 | −45.172 | 96.914 | 39.571 | 13.135 | 7.432 | 188.57 |
| Example 10 | 3 | 87 | 10 | −44.609 | 97.298 | 40.018 | 12.657 | 7.228 | 195.56 |
| Example 11 | 3 | 82 | 15 | −44.079 | 97.757 | 40.463 | 12.262 | 7.052 | 202.64 |
| Example 12 | 3 | 77 | 20 | −43.583 | 98.285 | 40.905 | 11.953 | 6.910 | 209.80 |
| Example 13 | 4 | 91 | 5 | −49.056 | 97.121 | 41.093 | 16.503 | 9.933 | 189.83 |
| Example 14 | 4 | 86 | 10 | −48.406 | 97.458 | 41.493 | 15.950 | 9.656 | 196.84 |
| Example 15 | 4 | 81 | 15 | −47.797 | 97.870 | 41.893 | 15.489 | 9.417 | 203.95 |
| Example 16 | 4 | 76 | 20 | −47.230 | 98.376 | 42.308 | 15.123 | 9.221 | 211.14 |
| Example 17 | 5 | 90 | 5 | −52.428 | 97.257 | 42.589 | 19.411 | 12.373 | 191.09 |
| Example 18 | 5 | 85 | 10 | −51.721 | 97.554 | 42.945 | 18.810 | 12.024 | 198.13 |
| Example 19 | 5 | 80 | 15 | −51.058 | 97.924 | 43.298 | 18.310 | 11.724 | 205.25 |
| Example 20 | 5 | 75 | 20 | −50.443 | 98.376 | 43.661 | 17.909 | 11.481 | 212.47 |
| Example 21 | 5 | 65 | 30 | −49.343 | 99.516 | 44.424 | 17.388 | 11.146 | 227.17 |
| Comparative | 0 | 100 | 0 | −29.7 | 94.7 | 33.8 | 0 | 0 | 177.9 |
| Example 1 | | | | | | | | | |
| Comparative | 5 | 55 | 40 | −48.389 | 100.9 | 45.209 | 17.18 | 11.003 | 242.23 |
| Example 2 | | | | | | | | | |
| Comparative | 10 | 60 | 30 | −60.462 | 98.617 | 50.487 | 26.812 | 20.608 | 233.93 |
| Example 3 | | | | | | | | | |
| Comparative | 10 | 50 | 40 | −59.363 | 99.857 | 51.014 | 26.61 | 20.293 | 249.18 |
| Example 4 | | | | | | | | | |
| Comparative | 15 | 75 | 10 | −69.598 | 95.428 | 55.71 | 32.767 | 28.813 | 210.78 |
| Example 5 | | | | | | | | | |
| Comparative | 15 | 55 | 30 | −66.973 | 96.902 | 55.971 | 31.717 | 27.193 | 240.66 |
| Example 6 | | | | | | | | | |

The specific components described in Table 1 are as follows.
R-744: Carbon dioxide
R-1234yf: 2,3,3,3-tetrafluoropropene
R-152a: 1,1-difluoroethane

### Experiment Example

### (1) GWP Calculation

Based on the global warming potential (GWP) according to the Intergovernmental Panel on Climate Change (IPCC) of R-744, R-1234yf and R-152a included in the mixed refrigerant composition according to the embodiments of the present disclosure, the global warming potentials (GWPs) of the mixed refrigerant compositions were calculated by calculating an arithmetic mean according to the weight ratio of each of R-744, R-1234yf and R-152a.

The global warming potential (GWP) according to the IPCC was based on the global warming potential (GWP) on the basis of 100 years.

The calculated global warming potentials (GWPs) are shown in Table 2 below.

TABLE 2

| Item | Global warming potential (GWP) |
|---|---|
| Example 1 | 7.15 |
| Example 2 | 13.30 |
| Example 3 | 19.45 |
| Example 4 | 25.6 |
| Example 5 | 7.15 |
| Example 6 | 13.30 |
| Example 7 | 19.45 |
| Example 8 | 25.60 |
| Example 9 | 7.15 |
| Example 10 | 13.30 |
| Example 11 | 19.45 |
| Example 12 | 25.60 |
| Example 13 | 7.15 |
| Example 14 | 13.30 |
| Example 15 | 19.45 |
| Example 16 | 25.60 |
| Example 17 | 7.15 |
| Example 18 | 13.30 |
| Example 19 | 19.45 |
| Example 20 | 25.60 |
| Example 21 | 37.90 |
| Comparative Example 1 | 1 |
| Comparative Example 2 | 50.2 |
| Comparative Example 3 | 37.9 |
| Comparative Example 4 | 50.2 |
| Comparative Example 5 | 13.3 |
| Comparative Example 6 | 37.9 |

### (2) Cooling Evaluation

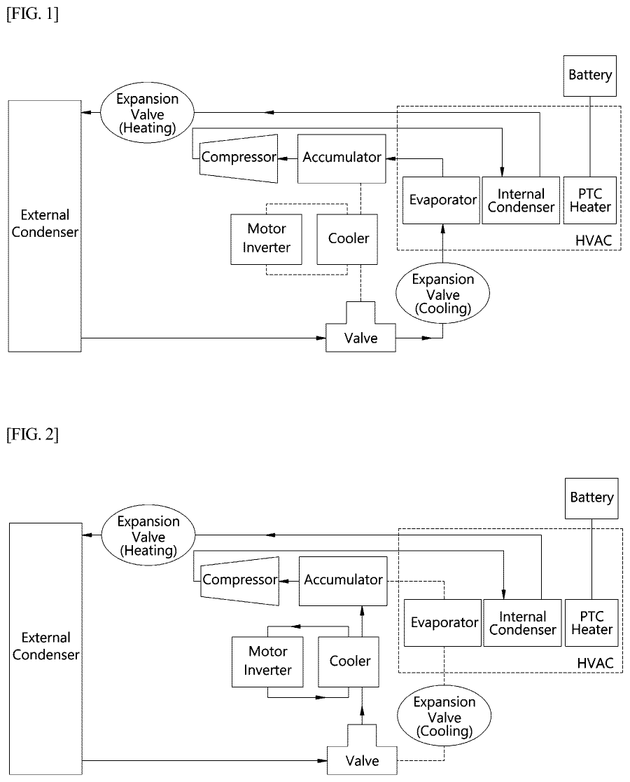

FIGS. 1 and 2 are schematic views illustrating the flow of a mixed refrigerant for heat exchange in a cooling mode or a heating mode of a heat exchanger according to various embodiments of the present disclosure, respectively.

The flow of the mixed refrigerant is shown by using directions of the arrows in FIGS. 1 and 2.

Referring to FIG. 1, in the cooling mode, the mixed refrigerant is compressed through a compressor, bypasses an internal condenser and an expansion valve (heating) in turn, releases heat in an external condenser, then expands in the expansion valve (cooling), and reabsorbs the heat through an evaporator.

Referring to FIG. 2, in the heating mode, the mixed refrigerant is compressed through the compressor, releases heat in the internal condenser, expands in the expansion valve (heating), absorbs heat from the external condenser, and then further absorbs the heat through a cooler.

Cooling evaluation and heating evaluation were performed using the refrigerant combinations of Examples 1 to 21 and Comparative Examples 1 to 6 through the above-described heat exchanger at different outside air temperatures.

The cooling evaluation was performed by setting the outside air temperature to 45° C., and the heating evaluation was performed by setting the outside air temperature to −7° C. and −20° C., respectively. Conditions for cooling evaluation and heating evaluation according to the above-described examples and comparative examples are shown in Table 3 below.

Specifically, the outside air temperature (° C.), refrigerant temperature at a condenser outlet, refrigerant supercooling degree at the condenser outlet, refrigerant temperature at an evaporator outlet, and refrigerant superheating degree at the evaporator outlet are shown in Table 3 below together.

TABLE 3

| | | | | Refrigerant | | Refrigerant |
|---|---|---|---|---|---|---|
| | | | Refrigerant | supercooling | Refrigerant | superheating |
| | | | temperature at | degree at | temperature at | degree at |
| | | Outside air | condenser | condenser | evaporator | evaporator |
| | Operation | temperature | outlet | outlet | outlet | outlet |
| Item | mode | (° C.) | (° C.) | (° C.) | (° C.) | (° C.) |
| Example 1 | Cooling | 45 | 55 | 10 | 10 | 8 |
| Example 1 | Heating | −7 | 40 | 10 | −20 | 1 |
| Example 1 | Heating | −20 | 20 | 10 | −29 | 1 |
| Example 2 | Cooling | 45 | 55 | 10 | 10 | 8 |
| Example 2 | Heating | −7 | 40 | 10 | −20 | 1 |
| Example 2 | Heating | −20 | 20 | 10 | −29 | 1 |
| Example 3 | Cooling | 45 | 55 | 10 | 10 | 8 |
| Example 3 | Heating | −7 | 40 | 10 | −20 | 1 |
| Example 3 | Heating | −20 | 20 | 10 | −29 | 1 |
| Example 4 | Cooling | 45 | 55 | 10 | 10 | 8 |
| Example 4 | Heating | −7 | 40 | 10 | −20 | 1 |
| Example 4 | Heating | −20 | 20 | 10 | −29 | 1 |
| Example 5 | Cooling | 45 | 55 | 10 | 10 | 8 |
| Example 5 | Heating | −7 | 40 | 10 | −20 | 1 |
| Example 5 | Heating | −20 | 20 | 10 | −29 | 1 |
| Example 6 | Cooling | 45 | 55 | 10 | 10 | 8 |
| Example 6 | Heating | −7 | 40 | 10 | −20 | 1 |
| Example 6 | Heating | −20 | 20 | 10 | −29 | 1 |
| Example 7 | Cooling | 45 | 55 | 10 | 10 | 8 |
| Example 7 | Heating | −7 | 40 | 10 | −20 | 1 |
| Example 7 | Heating | −20 | 20 | 10 | −29 | 1 |
| Example 8 | Cooling | 45 | 55 | 10 | 10 | 8 |
| Example 8 | Heating | −7 | 40 | 10 | −20 | 1 |
| Example 8 | Heating | −20 | 20 | 10 | −29 | 1 |
| Example 9 | Cooling | 45 | 55 | 10 | 10 | 8 |
| Example 9 | Heating | −7 | 40 | 10 | −20 | 1 |
| Example 9 | Heating | −20 | 20 | 10 | −29 | 1 |
| Example 10 | Cooling | 45 | 55 | 10 | 10 | 8 |
| Example 10 | Heating | −7 | 40 | 10 | −20 | 1 |
| Example 10 | Heating | −20 | 20 | 10 | −29 | 1 |
| Example 11 | Cooling | 45 | 55 | 10 | 10 | 8 |
| Example 11 | Heating | −7 | 40 | 10 | −20 | 1 |
| Example 11 | Heating | −20 | 20 | 10 | −29 | 1 |
| Example 12 | Cooling | 45 | 55 | 10 | 10 | 8 |
| Example 12 | Heating | −7 | 40 | 10 | −20 | 1 |
| Example 12 | Heating | −20 | 20 | 10 | −29 | 1 |
| Example 13 | Cooling | 45 | 55 | 10 | 10 | 8 |
| Example 13 | Heating | −7 | 40 | 10 | −20 | 1 |
| Example 13 | Heating | −20 | 20 | 10 | −29 | 1 |
| Example 14 | Cooling | 45 | 55 | 10 | 10 | 8 |
| Example 14 | Heating | −7 | 40 | 10 | −20 | 1 |
| Example 14 | Heating | −20 | 20 | 10 | −29 | 1 |
| Example 15 | Cooling | 45 | 55 | 10 | 10 | 8 |
| Example 15 | Heating | −7 | 40 | 10 | −20 | 1 |
| Example 15 | Heating | −20 | 20 | 10 | −29 | 1 |
| Example 16 | Cooling | 45 | 55 | 10 | 10 | 8 |
| Example 16 | Heating | −7 | 40 | 10 | −20 | 1 |
| Example 16 | Heating | −20 | 20 | 10 | −29 | 1 |
| Example 17 | Cooling | 45 | 55 | 10 | 10 | 8 |
| Example 17 | Heating | −7 | 40 | 10 | −20 | 1 |
| Example 17 | Heating | −20 | 20 | 10 | −29 | 1 |
| Example 18 | Cooling | 45 | 55 | 10 | 10 | 8 |
| Example 18 | Heating | −7 | 40 | 10 | −20 | 1 |
| Example 18 | Heating | −20 | 20 | 10 | −29 | 1 |
| Example 19 | Cooling | 45 | 55 | 10 | 10 | 8 |
| Example 19 | Heating | −7 | 40 | 10 | −20 | 1 |
| Example 19 | Heating | −20 | 20 | 10 | −29 | 1 |
| Example 20 | Cooling | 45 | 55 | 10 | 10 | 8 |
| Example 20 | Heating | −7 | 40 | 10 | −20 | 1 |
| Example 20 | Heating | −20 | 20 | 10 | −29 | 1 |
| Example 21 | Cooling | 45 | 55 | 10 | 10 | 8 |
| Example 21 | Heating | −7 | 40 | 10 | −20 | 1 |
| Example 21 | Heating | −20 | 20 | 10 | −29 | 1 |
| Comparative | Cooling | 45 | 55 | 10 | 10 | 8 |
| Example 1 | | | | | | |
| Comparative | Heating | −7 | 40 | 10 | −20 | 1 |
| Example 1 | | | | | | |
| Comparative | Heating | −20 | 20 | 10 | −29 | 1 |
| Example 1 | | | | | | |
| Comparative | Cooling | 45 | 55 | 10 | 10 | 8 |
| Example 2 | | | | | | |
| Comparative | Heating | −7 | 40 | 10 | −20 | 1 |
| Example 2 | | | | | | |
| Comparative | Heating | −20 | 20 | 10 | −29 | 1 |
| Example 2 | | | | | | |
| Comparative | Cooling | 45 | 55 | 10 | 10 | 8 |
| Example 3 | | | | | | |
| Comparative | Heating | −7 | 40 | 10 | −20 | 1 |
| Example 3 | | | | | | |
| Comparative | Heating | −20 | 20 | 10 | −29 | 1 |
| Example 3 | | | | | | |
| Comparative | Cooling | 45 | 55 | 10 | 10 | 8 |
| Example 4 | | | | | | |
| Comparative | Heating | −7 | 40 | 10 | −20 | 1 |
| Example 4 | | | | | | |
| Comparative | Heating | −20 | 20 | 10 | −29 | 1 |
| Example 4 | | | | | | |
| Comparative | Cooling | 45 | 55 | 10 | 10 | 8 |
| Example 5 | | | | | | |
| Comparative | Heating | −7 | 40 | 10 | −20 | 1 |
| Example 5 | | | | | | |
| Comparative | Heating | −20 | 20 | 10 | −29 | 1 |
| Example 5 | | | | | | |
| Comparative | Cooling | 45 | 55 | 10 | 10 | 8 |
| Example 6 | | | | | | |
| Comparative | Heating | −7 | 40 | 10 | −20 | 1 |
| Example 6 | | | | | | |
| Comparative | Heating | −20 | 20 | 10 | −29 | 1 |
| Example 6 | | | | | | |

Cooling and heating analysis for the refrigerant combinations of the examples and comparative examples shown in Table 3 were verified through the zero-dimensional OD analysis program Cycle-D (provided by NIST). Specifically, volumetric capacity, temperature and pressure at the compressor outlet were evaluated through the cooling and heating analysis.

The volumetric capacity was calculated using Equation 1 below.

$$Volumetric capacity = \frac{\begin{matrix}Cooling performance ( or heating performance ) \\ per unit mass\end{matrix}}{Refrigerant specific volume} \times Compressor volumetric efficiency \qquad [ Equation 1 ]$$

Evaluation results are shownin Tables 4 to 6 below.

TABLE 4
Cooling evaluation (Outside air temperature: 45° C.)

| | Volumetric | Pressure at | Temperature at |
|---|---|---|---|
| | capacity | compressor outlet | compressor outlet |
| Item | (kJ/m³) | (kPaA) | (° C.) |
| Example 1 | 2618.9 | 1597.1 | 71.2 |
| Example 2 | 2651.2 | 1601.7 | 72.3 |
| Example 3 | 2678.2 | 1603.8 | 73.4 |
| Example 4 | 2699.9 | 1603.7 | 74.6 |
| Example 5 | 2654.6 | 1722.7 | 74.2 |
| Example 6 | 2686.5 | 1724.4 | 75.3 |
| Example 7 | 2712.7 | 1723.9 | 76.4 |
| Example 8 | 2733.5 | 1721.3 | 77.6 |
| Example 9 | 2690.5 | 1851.0 | 77.1 |
| Example 10 | 2721.8 | 1849.7 | 78.2 |
| Example 11 | 2747.6 | 1846.3 | 79.3 |
| Example 12 | 2767.2 | 1841.3 | 80.4 |
| Example 13 | 2726.5 | 1981.2 | 79.9 |
| Example 14 | 2757.2 | 1976.8 | 81.0 |
| Example 15 | 2782.4 | 1970.6 | 82.1 |
| Example 16 | 2801.3 | 1962.9 | 83.3 |
| Example 17 | 2762.8 | 2112.7 | 82.6 |
| Example 18 | 2793.1 | 2105.1 | 83.7 |
| Example 19 | 2817.5 | 2096.1 | 84.9 |
| Example 20 | 2835.4 | 2085.7 | 86.0 |
| Example 21 | 2853.7 | 2062.0 | 88.4 |
| Comparative | 2545.5 | 1464.7 | 67.0 |
| Example 1 | | | |
| Comparative | 2856.8 | 2035.0 | 91.0 |
| Example 2 | | | |
| Comparative | 3017.9 | 2652.2 | 100.7 |
| Example 3 | | | |
| Comparative | 3001.3 | 2603.6 | 103.6 |
| Example 4 | | | |
| Comparative | 3174.2 | 3368.8 | 105.4 |
| Example 5 | | | |
| Comparative | 3190.1 | 3220.8 | 110.9 |
| Example 6 | | | |

TABLE 5
Heating evaluation (Outside air temperature: −7° C.)

| | Volumetric | Pressure at | Temperature at |
|---|---|---|---|
| | capacity | compressor outlet | compressor outlet |
| Item | (kJ/m³) | (kPaA) | (° C.) |
| Example 1 | 1369.8 | 1128.4 | 56.5 |
| Example 2 | 1385.6 | 1130.1 | 58.3 |
| Example 3 | 1398.2 | 1130.2 | 60.1 |
| Example 4 | 1407.3 | 1128.8 | 61.9 |
| Example 5 | 1410.5 | 1234.8 | 60.3 |
| Example 6 | 1425.6 | 1233.7 | 62.1 |
| Example 7 | 1437.0 | 1231.1 | 63.8 |
| Example 8 | 1445.3 | 1227.4 | 65.6 |
| Example 9 | 1450.9 | 1343.3 | 63.9 |
| Example 10 | 1465.3 | 1339.3 | 65.6 |
| Example 11 | 1476.3 | 1334.1 | 67.4 |
| Example 12 | 1483.2 | 1328.0 | 69.2 |
| Example 13 | 1491.4 | 1453.3 | 67.4 |
| Example 14 | 1505.1 | 1446.3 | 69.1 |
| Example 15 | 1514.8 | 1438.5 | 70.9 |
| Example 16 | 1521.0 | 1429.9 | 72.7 |
| Example 17 | 1532.0 | 1564.0 | 70.7 |
| Example 18 | 1544.6 | 1554.2 | 72.4 |
| Example 19 | 1553.1 | 1543.6 | 74.2 |
| Example 20 | 1558.8 | 1532.5 | 76.1 |
| Example 21 | 1558.2 | 1509.3 | 79.9 |
| Comparative | 1309.4 | 1018.4 | 50.8 |
| Example 1 | | | |
| Comparative | 1548.3 | 1484.9 | 84.0 |
| Example 2 | | | |
| Comparative | 1734.1 | 1998.5 | 95.1 |
| Example 3 | | | |
| Comparative | 1709.2 | 1954.8 | 99.5 |
| Example 4 | | | |
| Comparative | 1944.1 | 2603.6 | 99.3 |
| Example 5 | | | |
| Comparative | 1909.7 | 2465.4 | 107.8 |
| Example 6 | | | |

TABLE 6
Heating evaluation (Outside air temperature: −20° C.)

| | Volumetric | Pressure at | Temperature at |
|---|---|---|---|
| | capacity | compressor outlet | compressor outlet |
| Item | (kJ/m³) | (kPaA) | (° C.) |
| Example 1 | 1060.3 | 673.2 | 39.3 |
| Example 2 | 1067.9 | 672.7 | 40.9 |
| Example 3 | 1073.1 | 671.4 | 42.6 |
| Example 4 | 1075.6 | 669.2 | 44.3 |
| Example 5 | 1093.8 | 753.6 | 43.7 |
| Example 6 | 1100.7 | 750.6 | 45.3 |
| Example 7 | 1105.1 | 747.0 | 47.0 |
| Example 8 | 1106.8 | 742.9 | 48.7 |
| Example 9 | 1127.0 | 835.3 | 47.9 |
| Example 10 | 1133.1 | 829.9 | 49.5 |
| Example 11 | 1136.7 | 824.1 | 51.1 |
| Example 12 | 1137.3 | 817.9 | 52.8 |
| Example 13 | 1159.7 | 918.0 | 51.8 |
| Example 14 | 1165.1 | 910.1 | 53.4 |
| Example 15 | 1167.8 | 902.0 | 55.0 |
| Example 16 | 1167.5 | 893.8 | 56.7 |
| Example 17 | 1192.1 | 1000.9 | 55.5 |
| Example 18 | 1196.8 | 990.7 | 57.1 |
| Example 19 | 1198.7 | 980.3 | 58.7 |
| Example 20 | 1197.6 | 970.1 | 60.5 |
| Example 21 | 1187.6 | 950.0 | 64.2 |
| Comparative | 1014.9 | 591.7 | 32.9 |
| Example 1 | | | |
| Comparative | 1170.1 | 930.5 | 68.1 |
| Example 2 | | | |
| Comparative | 1324.0 | 1309.3 | 80.6 |
| Example 3 | | | |
| Comparative | 1294.3 | 1274.5 | 85.0 |
| Example 4 | | | |
| Comparative | 1508.9 | 1761.1 | 85.6 |
| Example 5 | | | |
| Comparative | 1458.1 | 1647.3 | 94.0 |
| Example 6 | | | |

Referring to Table 4, in the examples within the scope of the present disclosure, the volumetric capacity in the cooling evaluation (outside air temperature of 45° C.) was 2618.9 kJ/m³ or more, and the temperature at the compressor outlet was 88.4° C. or lower.

The volumetric capacity is an amount of energy that the refrigerant can include per unit volume. The larger the volumetric capacity, the lager the amount of energy that the same volume of refrigerant can move, thus it is a refrigerant with good air conditioning performance.

In the case of Comparative Example 1 using R-1234yf alone, the volumetric capacity was decreased compared to the examples.

Referring to Comparative Examples 3 and 4, when including R-152a in an amount of 30 wt. % or more based on the total weight of the mixed refrigerant composition, it shown a tendency for the cooling volumetric capacity to converge, whereas for the pressure and temperature at the compressor outlet to be increased.

Referring to the comparative examples, when increasing the content of R-744, it shown a tendency for the pressure and temperature at the compressor outlet to be increased.

Referring to Table 5, in the examples within the scope of the present disclosure, the volumetric capacity in the heating evaluation (outside air temperature of −7° C.) was 1369.8 kJ/m³ or more, and the temperature at the compressor outlet was 79.9° C. or lower.

In the case of Comparative Example 1 using R-1234yf alone, the volumetric capacity was decreased compared to the examples.

Referring to Comparative Examples 3 and 4, when including R-152a in an amount of 30 wt. % or more based on the total weight of the mixed refrigerant composition, it shown a tendency for the cooling volumetric capacity to converge, whereas for the pressure and temperature at the compressor outlet to be increased.

Referring to the comparative examples, when increasing the content of R-744, it shown a tendency for the pressure and temperature at the compressor outlet to be increased.

Referring to Table 6, in the examples within the scope of the present disclosure, the volumetric capacity in the heating evaluation (outside air temperature of −20° C.) was 1060.3 kJ/m³ or more, and the temperature at the compressor outlet was 64.2° C. or lower.

In the case of Comparative Example 1 using R-1234yf alone, the volumetric capacity was decreased compared to the examples.

Referring to Comparative Examples 3 and 4, when including R-152a in an amount of 30 wt. % or more based on the total weight of the mixed refrigerant composition, it shown a tendency for the cooling volumetric capacity to converge, whereas for the pressure and temperature at the compressor outlet to be increased.

Referring to the comparative examples, when increasing the content of R-744, it shown a tendency for the pressure and temperature at the compressor outlet to be increased.

Referring to the results shown in Tables 5 to 7, in one embodiment, the mixed refrigerant including all of R-744, R-1234yf and R-152a is used rather than the case of using a refrigerant including R-1234yf alone. In addition, in one embodiment, the maximum content of R-744 to 10 wt. % is limited based on the total weight of the mixed refrigerant composition.

In addition, further considering the fact that the GWP is increased when increasing the content of R-152a, in one embodiment, the maximum content of R-152a to 30 wt. % is limited based on the total weight of the mixed refrigerant composition.

What is claimed is:

1. A mixed refrigerant composition comprising:
carbon dioxide, 2,3,3,3-tetrafluoropropene and 1,1-difluoroethane,
wherein a content of the carbon dioxide ranges from 1 to 10% by weight based on a total weight of the mixed refrigerant composition,
a content of the 2,3,3,3-tetrafluoropropene ranges from 65 to 95% by weight based on the total weight of the mixed refrigerant composition,
a content of the 1,1-difluoroethane is 1 to 30% by weight based on the total weight of the mixed refrigerant composition, and
a boiling point of the mixed refrigerant composition at 1 atm ranges from −65 to −30° C.

2. The mixed refrigerant composition according to claim 1, wherein the mixed refrigerant composition consists of the carbon dioxide, the 2,3,3,3-tetrafluoropropene, and the 1,1-difluoroethane.

3. The mixed refrigerant composition according to claim 1, wherein the content of the 1,1-difluoroethane is 13 to 25% by weight based on the total weight of the mixed refrigerant composition.

4. The mixed refrigerant composition according to claim 1, wherein the content of the 1,1-difluoroethane ranges from 18 to 23% by weight based on the total weight of the mixed refrigerant composition.

5. The mixed refrigerant composition according to claim 1, wherein a ratio of the content of the 2,3,3,3-tetrafluoropropene to the content of the carbon dioxide based on the total weight of the mixed refrigerant composition ranges from 6 to 95.

6. The mixed refrigerant composition according to claim 1, wherein a ratio of the content of the 1,1-difluoroethane to the content of the carbon dioxide based on the total weight of the mixed refrigerant composition ranges from 0.5 to 30.

7. The mixed refrigerant composition according to claim 1, wherein a ratio of the content of the 2,3,3,3-tetrafluoropropene to the content of the 1,1-difluoroethane based on the total weight of the mixed refrigerant composition ranges from 2 to 19.

8. The mixed refrigerant composition according to claim 1, wherein a critical temperature of the mixed refrigerant composition ranges from 90 to 100° C.

9. The mixed refrigerant composition according to claim 1, wherein a critical pressure of the mixed refrigerant composition ranges from 30 to 51 bar.

10. The mixed refrigerant composition according to claim 1, wherein a temperature glide at a pressure of 1.5 bar of the mixed refrigerant composition ranges from 3 to 29° C.

11. The mixed refrigerant composition according to claim 1, wherein a temperature glide at a pressure of 15 bar of the mixed refrigerant composition ranges from 2 to 23° C.

12. The mixed refrigerant composition according to claim 1, wherein a latent heat at −25° C. of the mixed refrigerant composition ranges from 150 to 250 kJ/kg.

13. The mixed refrigerant composition according to claim 1, wherein a global warming potential of the mixed refrigerant composition ranges from 1 to 40.

14. A heat pump comprising the mixed refrigerant composition according to claim 1.

15. A mixed refrigerant composition comprising:
a natural refrigerant; and
a mixture of two or more artificial refrigerants, the artificial refrigerants having a zero ozone depleting potential;
wherein
the mixed refrigerant composition includes no chlorine, and
a content of the natural refrigerant ranges from 1 to 10% by weight based on a total weight of the mixed refrigerant composition,
a content of a first artificial refrigerant of the two artificial refrigerants ranges from 65 to 90% by weight based on the total weight of the mixed refrigerant composition, and the first artificial refrigerant has a global warming potential of less than 4,
a content of a second artificial refrigerant of the two artificial refrigerant ranges from 1 to 30% by weight based on the total weight of the mixed refrigerant composition, and the second artificial refrigerant has a global warming potential of less than 150, and
a boiling point for the mixed refrigerant composition at 1 atm ranges from −65 to −35° C.

16. The mixed refrigerant composition according to claim 15, wherein the natural refrigerant comprises at least one or more of ammonia, carbon dioxide, propane, propylene, and butane.

17. The mixed refrigerant composition according to claim 15, wherein the artificial refrigerants comprise hydrofluorocarbon (HFC)-based refrigerants and hydrofluoroolefin (HFO)-based refrigerants.
